(19) United States
(12) Patent Application Publication
(10) Pub. No.: US 2019/0139159 A1
(43) Pub. Date: May 9, 2019

(54) ENERGY OPPORTUNITY OPTIMIZATION SYSTEM

(71) Applicant: Drift Marketplace, Inc., Seattle, WA (US)

(72) Inventors: Mushfiqur Rahman Sarker, Seattle, WA (US); Herbert Alan Tilley, Issaquah, WA (US); Edwin Eugene McKenzie, III, Seattle, WA (US); Gregory William Robinson, Covington, WA (US)

(21) Appl. No.: 15/982,953

(22) Filed: May 17, 2018

Related U.S. Application Data
(60) Provisional application No. 62/508,323, filed on May 18, 2017.

(51) Int. Cl. G06Q 50/06; G06Q 40/04; G06N 5/04

(52) U.S. Cl. CPC G06Q 50/06; G06N 5/04; G06Q 40/04

(57) ABSTRACT

A system is provided to identify energy opportunities for an entity (e.g., supplier or consumer) to help ensure than an objective of the entity is met. An objective of an entity may be to consume electrical power that is at least 50% provided by clean energy. Another objective may be to reduce energy consumption during periods of electrical shortages. Yet another objective may be to supply electrical power during periods of high price and consume electrical power during periods of low price. The system inputs data relating to the day-ahead energy market, the real-time energy market, historical supply and demand, forecast supply and demand, and so on and identifies various energy opportunities for entities. The system then notifies the entities of the energy opportunities that may be of interest so that the entities can decide whether to take advantage of the energy opportunities.

### CROSS-REFERENCE TO RELATED APPLICATION

This application claims the benefit of U.S. Provisional Application No. 62/508,323, filed on May 18, 2017, which is hereby incorporated by reference in its entirety.

### BACKGROUND

The electrical grid is a network of suppliers and consumers of energy. The electrical grid includes a transmission grid and a distribution grid. Suppliers of large amounts of energy (e.g., hydroelectric plants and nuclear plants) supply high voltage electrical power to the transmission grid for transmission to substations. The substations step the high voltage electrical power of the transmission grid to lower voltage electrical power of the distribution grid. Consumers connect to the distribution grid to obtain their electrical power. Various suppliers such as city power plants, solar farms, and wind farms may also connect to the distribution grid to supply electrical power.

The management of an electrical grid may include complex interactions between suppliers and consumers to ensure a proper match between the amount of electrical power supplied and consumed. In the United States, various Independent System Operators (“ISOs”), including Regional Transmission Organizations, coordinate, control, and monitor the electrical grid, typically as regulated by the Federal Energy Regulatory Commission, for a particular region such as a state or group of states. The ISOs forecast load and coordinate supply of electrical power to meet the forecast load for their regions.

The ISOs provide a wholesale market in which suppliers offer to sell electrical power for an offer price and consumers bid to purchase electrical power for a bid price. Each ISO provides a day-ahead (“DA”) energy market in which offers and bids are collected for each target period (e.g., hour) of the following day. The DA energy market matches offers and bids and directs suppliers of the matched offers to provide the offered electrical power to the consumer of the matched bids. The ISOs also provide a real-time (“RT”) market that operates in a manner similar to the DA energy market except that offers and bids, for example, for the next target period (e.g., 15 minutes) are matched to help account for fluctuations (e.g., caused by failures and weather events) in the forecast supply and demand for electrical power. Based on the matched bids and offers, each ISO provides a locational-based marginal price (“LBMP”) that suppliers collect and consumers pay (e.g., in $/MWh) during each target period. The DA energy market and the RT energy market are referred to as the energy marketplace. The ISOs may also provide various incentives to help ensure that the supply is sufficient for the demand. For example, the ISOs may pay suppliers to hold capacity in reserve (e.g., spinning reserves) to help meet unexpected supply shortages. The ISOs may also pay consumers to reduce their consumption to also help reduce the impact of unexpected supply shortages. The participants in the energy marketplace thus include suppliers and consumers of transmission grid and distribution grid.

### BRIEF DESCRIPTION OF THE DRAWINGS

FIG. 1 is a flow diagram that illustrates the overall processing of the EOO system in some embodiments.

FIG. 2 is a block diagram that illustrates components of the EOO system in some embodiments.

FIG. 3 is a flow diagram that illustrates the processing of a train forecaster component of the EOO system in some embodiments.

FIG. 4 is a flow diagram that illustrates the processing of a generate forecast component of the EOO system in some embodiments.

FIG. 5 is a flow diagram that illustrates the processing of an identify optimal energy opportunities component of the EOO system in some embodiments.

FIG. 6 is a flow diagram that illustrates the processing of an establish asset models component of the EOO system in some embodiments.

FIG. 7 is a flow diagram that illustrates the processing of an establish asset model component of the EOO system in some embodiments.

FIG. 8 is a flow diagram that illustrates the processing of an identify threshold energy opportunities component of the EOO system in some embodiments.

FIG. 9 is a flow diagram that illustrates processing of an identify priority energy opportunities component of the EOO system in some embodiments.

### DETAILED DESCRIPTION

A method and a system are provided for identifying energy opportunities to optimize an objective of an entity that is a participant in the energy marketplace. Energy marketplaces refer to transactional, open-access, and/or competitive marketplaces that may be available at the transmission-level (“TL”) or distribution-level (“DL”) in a region. For example, an DL energy marketplace at the distribution-level enables local parties to participate in economic opportunities provided by local power utilities, whereas the ISO energy marketplace at the transmission-level provides wholesale market opportunities to those qualified to participate encompassing the region of operation. In some embodiments, an energy opportunity optimization (“EOO”) system is provided to identify energy opportunities for an entity (e.g., supplier or consumer) to help ensure than an objective of the entity is met. An objective of an entity may be to consume electrical power that is at least 50% provided by clean energy. Another objective may be to reduce energy consumption during periods of electrical shortages. Yet another objective may be to supply electrical power during periods of high price and consume electrical power during periods of low price. For example, the management of a large apartment complex may provide charging stations for the electrical vehicles of its tenants. The management may provide incentives to the owners of the electrical vehicles to allow the batteries to be discharged to supply electrical power during times of high demand (e.g., 6:00-10:00 p.m.) and to be charged during times of low demand (e.g., 2:00-6:00 a.m.). The EOO system inputs data relating to the DA energy market, the RT energy market, historical supply and demand, forecast supply and demand, and so on and identifies various energy opportunities for entities. The EOO system then notifies the entities of the energy opportunities that may be of interest so that the entities can decide whether to take advantage of the energy opportunities. Continuing with the apartment complex example, if the RT energy market price is lower than expected during a time in which demand is normally high, the management of the apartment complex may decide to not discharge the batteries or only partially discharge the batteries.

In some embodiments, the EOO system identifies energy opportunities for assets during a target period. A target period may be defined for various intervals appropriate to the energy market. For example, a target period may be each hour of the following day with the DA energy market or the next 15 minutes with the RT energy market. The assets include suppliers (e.g., generators) and loads (e.g., HVAC systems) of electrical power. The EOO system collects various attributes of the assets so that the energy opportunities can be tailored to the specific characteristics of the assets. For example, a battery that both supplies and consumes electrical power may have a capacity rating attribute, a discharge efficiency attribute, a charge efficiency attribute, a minimum charge attribute, a discharge window attribute, and so on. The EOO system accesses historical data relating to the electrical marketplace. The historical data may include DA and RT energy market prices during past target periods, supply and demand during target periods, temperature during target periods, and so on. The EOO system may generate forecasts for various forecast parameters. For example, the forecast parameters may include price per target period, demand per target period, energy mix (e.g., solar v. nuclear) per target period, and so on. The EOO system may use various machine learning techniques to generate the forecasts.

After collecting the attributes, accessing the historical data, and generating the forecasts, the EOO system then identifies the energy opportunities. For each asset, the EOO system establishes constraints for the asset based on the attributes of the asset and establishes an asset model for the energy opportunities. For example, the constraints for a battery may include maintaining a certain minimum state-of-charge and having a maximum state-of-charge by a certain time of day. To establish an asset model for an asset, the EOO system may combine various objective functions for energy opportunities for the asset into a combined objective function subject to the established constraints. The objective functions are based on one or more of the attributes of the assets, historical data, or values for the forecast parameters. For example, an objective function to minimize the cost of charging a battery may be based on discharging revenue and charging expense subject to the constraints for the battery. After the asset models are established for the assets, the EOO system combines the asset models along with the constraints into an overall model (e.g., for the owner of the assets) and then identifies a solution for the overall model that optimizes the energy opportunities for the assets during the target period or a series of target periods. The EOO system may apply various well-known optimization techniques to identify the solution. Some suitable techniques are described in Boyd, S. and Vandenberghe, L., “Convex Optimization,” Cambridge University Press, 2004.

In some embodiments, the EOO system organizes assets into end-point groups (“EPGs”). An entity that owns (or manages) assets can have the assets registered with the EOO system as an EPG. The EOO system provides the entity with information describing energy opportunities for the assets of the EPG. The energy opportunities can be defined in terms of any type of objective that an entity seeks for its assets. For example, an entity may simply want to be informed of the price or whether the demand for a particular asset exceeds a threshold so that the entity can control its assets to react accordingly. Alternatively, an entity may want the EOO system to recommend an optimal energy opportunity that is based on the specific assets and objectives of the entity. Energy opportunities are generally price-based in the sense that given that the constraints of an entity are satisfied, the entity would typically seek to maximize its revenues and/or minimize its costs. The energy opportunities can be based on factors such as maximizing the amount of clean energy consumed, maximizing battery charge, and so on. An entity may seek to reduce volatility in its energy prices. In such a case, the entity may participate in the DA energy market to maximize revenue and/or minimize cost. In such a case, the EOO system may provide recommendations of pricings for offers and bids based on the constraints of the assets of the entity. Another entity with fast-acting assets, such as an energy storage system, can schedule to operate as a load (charging) or a supplier (discharging) at any given time to exploit the volatility in the RT energy market. The EOO system may provide recommendations such as the level of charge to seek at any given time. Another entity, such as a large-scale generator, can either schedule its supply directly into the DA energy market or keep part of its available supply at any given period to take advantage of the revenue based on the reserve market. Another entity may seek to exploit negative pricing in which a load is paid to consume energy when supply outstrips demand. Another entity may seek to exploit scarcity pricing opportunities (e.g., weather events) where price is high due to failures of generators or a portion of the transmission or distribution grid. Each entity may use the EOO system to take advantage of one or more energy opportunities identified by the EOO system. Indeed, each entity can define its own objective functions and constraints to have the energy opportunities customized to its business, political, environmental, or other concerns. For example, the energy opportunities may be based on advance pricing, real-time pricing, reserve pricing, negative pricing, scarcity pricing, incentive pricing, emissions pricing, capacity pricing, and so on.

In some embodiments, the objective function for an energy opportunity may be specified mathematically as

$$maximize$$

$$subject to and$$

$${c}^{T} x$$

$$Ax \leq b , \\ x \geq 0 , \\ x ∈ {ℤ}^{n} ,$$

where x is a vector whose values are to be determined to maximize the sum of the products of the values times the weights represented by vector c. The subject to statements specify the constraints on the values of vector x. The objective function for an energy storage system may be represented by the following:

$$Maximize profit = {\sum }_{t ∈ T} {\sum }_{n ∈ N} {Rev}_{n} ( {y}_{t} ) - {\sum }_{t ∈ T} {\sum }_{j ∈ J} {Costs}_{j} ( {y}_{t} )$$

where T represents the number of periods, N represents the number of energy opportunities, and J represents the number of assets. Rev represents the revenue for energy opportunity n during period t, and Costs represents the costs for asset j during period t.

In the following, an example overall model representing the energy opportunities for an aggregator (e.g., owner of an apartment complex) of energy storage systems (e.g., batteries of electrical vehicles (“EVs”) of tenants) is described. In this example, the aggregator participates in the DA energy market and the DA regulation (or reserve) market. In the DA energy market, the aggregator is a price-taker who submits quantity-only zero-price bids. In the DA regulation market, the aggregator complies with the pre-defined requirements of the DA regulation market. From the aggregator's perspective, up regulation is equivalent to supplying energy to the grid by discharging its EVs (REGUP). The aggregator obtains the capacity revenue for being on stand-by for regulation up service and the RT energy price for deploying the capacity if required by the ISO. On the other hand, down regulation is equivalent to taking energy from the grid and charging EV batteries (REGDN). Unlike up regulation, the aggregator obtains only the capacity revenue for being on stand-by when providing down regulation. This is the case because EVs can use the additional energy for transportation purposes and thus this does not entail additional compensation in the RT energy market.

The aggregator can also schedule EVs to stop charging (STOPCHG) or discharging (STOPDSG), which are part of regulation up and down services, respectively. This can only occur, however, if a subset of its EVs are already charging from or discharging to the grid in the energy market and are interrupted voluntarily. The scheduling of charging and discharging in the energy, regulation up, and regulation down markets are considered by the overall model.

After the DA energy market clears, the aggregator is aware of which periods it must be on stand-by to provide regulation services. With such information, the aggregator can then readjust its EV schedule and, if needed, can also participate in the RT energy market. The overall model for the aggregator is represented by the following objective function as follows:

max{r^{em}+r^{cap}+r^{depl}c−^{regup}−c^{regdn}−c^{deg}} (1)

where r^{em} is DA energy market revenue, r^{cap} is the DA regulation market revenue for capacity, r^{depl} is the expected revenue for deployment in real time, and in terms of costs, c^{regup} is the cost for regulation up service, c^{regdn} is the cost for regulation down service, and c^{deg} is the battery degradation cost that must be compensated to consumers.

The DA energy market revenue r^{em} is given as follows:

$${r}^{em} = Δ t {\sum }_{t ∈ T} {\sum }_{v ∈ V} {λ}_{t}^{DA} ( {η}_{v}^{dsg} \cdot {p}_{t , v}^{emdsg} - {p}_{t , v}^{emchg} ) \qquad ( 2 )$$

where λₜ^{DA} is the DA energy market price, ηᵥ^{dsg} is the battery discharge efficiency, and p_{t,v}^{emdsg} and p_{t,v}^{emchg} are the discharge and charging powers specifically targeted for the energy market, respectively. The revenue r^{cap} is obtained from the DA regulation market as follows:

$${r}^{cap} = {\sum }_{t ∈ T} {\sum }_{b ∈ B} [ ( {w}_{t , b}^{up} {λ}_{t , b}^{up} ) {π}^{a} {p}_{t}^{up} + ( {w}_{t , b}^{dn} {λ}_{t , b}^{dn} ) {φ}^{a} {p}_{t}^{dn} ] \qquad ( 3 )$$

where λ_{t,b}^{up} and λ_{t,b}^{dn} are the DA regulation up and down capacity prices, respectively, obtained from capacity price cumulative density function (“CDF”) curves that map various combinations of probabilities to profit. The binary variable w_{t,b}^{up}∈{1, 0} activates only one segment of the capacity price CDF curves as a function of the probability π^{a} of acceptance for up regulation. A similar rationale applies for w_{t,b}^{dn} as a function of probability ϕ^{a} of acceptance for down regulation. The revenue term takes into account the likelihood of capacity offers to be accepted. The power pₜ^{up} and pₜ^{dn} are the regulation up and down capacity offers to the market. This revenue stream only considers the capacity revenue; however, if the capacity is deployed by the ISO, additional revenue for deployment r^{depl} should be accounted at RT prices as follows:

$${r}^{depl} = {π}^{a} {π}^{d} {η}^{dsg} {\sum }_{t ∈ T} {\sum }_{v ∈ V} {\sum }_{b ∈ B} ( {v}_{t , b}^{up} {λ}_{t , b}^{RT} ) ( {e}_{t , v}^{regup} + {e}_{t , v}^{stopdsg} ) \qquad ( 4 )$$

where λ_{t,b}^{RT} is the RT energy price obtained from the CDF curve, e_{t,v}^{regup} is the expected energy deployment for regulation up service, and e_{t,v}^{stopdsg} is the energy in regulation up service that is only potentially scheduled in the same period t in which energy market discharging (EMDSG) is scheduled. Each segment of the real-time energy price CDF curve has a binary variable v_{t,b}^{up}∈{1, 0}. This variable determines which segment b is active, and it is a function of the probability π^{d} of deployment for up regulation. Therefore, r^{depl} represents the revenue that may be obtained from deployment in the RT energy market. This, however, assumes the aggregator would deploy a fraction of its capacity offer and ignores the risk of being deployed more than it anticipated. To account for this outcome, the cost c^{regup} for regulation up service is as follows:

$${c}^{regup} = {π}^{a} {π}^{d} ( 1 - {π}^{d} ) {\sum }_{t ∈ T} {\sum }_{b ∈ B} ( {v}_{t , b}^{up} {λ}_{t , b}^{RT} ) ( {p}_{t}^{up} - {π}^{a} {π}^{d} {p}_{t}^{up} ) \qquad ( 5 )$$

where the difference between the capacity offers pₜ^{up} and the expected deployment π^{a}π^{d}pₜ^{up} determines the amount of shortage that may need to be purchased in the RT energy market. This situation can occur with a conditional probability product of π^{a}π^{d}(1−π^{d}), where (1−π^{d})=π^{short}. This case covers the penalty for being unable to deploy in the RT energy market. A similar rationale applies for regulation down service as follows:

$${c}^{regdn} = {φ}^{a} {φ}^{d} ( 1 - {φ}^{d} ) {\sum }_{t ∈ T} {\sum }_{b ∈ B} ( {v}_{t , b}^{dn} {λ}_{t , b}^{RT} ) ( {p}_{t}^{dn} - {φ}^{a} {φ}^{d} {p}_{t}^{dn} ) \qquad ( 6 )$$

Since the aggregator is not the owner of the EV batteries, it must compensate EV owners for degrading their batteries. In this work, it is assumed the degradation characteristic is sensitive to the number of cycles and insensitive to the depth of discharge. The degradation cost is as follows:

$${c}^{deg} = {\sum }_{v ∈ V} {C}_{v}^{bat} \vert \frac{{m}_{v}}{100} \vert [ \frac{Δ t {\sum }_{( t ∈ T )} ( {p}_{t , v}^{emdsg} + {p}_{t , v}^{emchg} ) - {ξ}_{v}}{{BC}_{v}} + \frac{{\sum }_{( t ∈ T )} ( {π}^{a} {e}_{t , v}^{regup} + {φ}^{a} {e}_{t , v}^{regdn} )}{{BC}_{v}} ] \qquad ( 7 )$$

where BCᵥ is the battery energy capacity, Cᵥ^{bat} is the battery cost, ξᵥ is the total energy for motion, and mᵥ is the linear approximated slope of the battery life as a function of the number of cycles. The value of mᵥ may be estimated from manufacturer datasheets. In equation 7, the aggregator must compensate EVs for discharging to the grid for energy market arbitrage as determined by the term p_{t,v}^{emdsg}. On the other hand, for energy obtained for charging from the energy market, it only needs to compensate additional energy on top of the motion needs as determined by subtracting ξᵥ. For the regulation services, only the components of the service that degrade the battery are included, that is, e_{t,v}^{regup} and e_{t,v}^{regdn}, because stop charge and stop discharge actions do not degrade the battery; instead, they only interrupt the actions of the EVs in the period.

Equations 2 to 7 correspond to the objective functions for various energy opportunities that are combined to form the overall model of equation 1. The overall model is subject to various constraints. The first set of constraints of equations 8 and 9 calculate the capacity offer for regulation up and down, respectively. In these constraints, the sum of the energy for each service calculated from each EV must equal the total regulation offer. Furthermore, these constraints relate the offered capacity in the DA regulation market to the expected deployment in the RT regulation market. The capacity offer is multiplied by the probability π^{d} for regulation up in equation 8 and ϕ^{d} for regulation down in equation 9, to get RT deployment.

$$\begin{matrix}\begin{matrix}{p}_{t}^{up} {π}^{d} Δ t = {\sum }_{v ∈ V} ( {e}_{t , v}^{regup} + {e}_{t , v}^{stopchg} ) & ∀ t ∈ T\end{matrix} & ( 8 ) \\ \begin{matrix}{p}_{t}^{dn} {φ}^{d} Δ t = {\sum }_{v ∈ V} ( {e}_{t , v}^{regdn} + {e}_{t , v}^{stopdsg} ) & ∀ t ∈ T\end{matrix} & ( 9 )\end{matrix}$$

Constraints of equations 10 to 15 determine the energy state-of-charge (eSOC) soc_{t,v} of each EV and the energy of each product offered in the market. In equation 10, the eSOC is dependent on the previous state, power obtained from the energy market p_{t,v}^{emchg} and injected to the energy market p_{t,v}^{emdsg}, motion needs, and motion schedule S_{t,v}. This same constraint allows arbitrage in the energy market. However, before arbitrage can be scheduled, the motion needs must be fulfilled which are obtained from the energy market, because unlike the regulation market, this market is open to all participants without any preset ISO requirements. This is managed in the constraint of equation 11. If additional capacity is available in the batteries, they can be scheduled to provide regulation down/up service as shown in the constraints of equations 12 and 13. At all time periods, the eSOC must be within the defined minimum and maximum bounds as shown in the constraint of equation 14. The constraint of equation 15 ensures that the total energy at the end of the optimization horizon is the same as it was at the beginning of the day. This ensures that the aggregator returns the EV batteries to their initial state.

$$\begin{matrix} {soc}_{t , v} = {soc}_{t - 1 , v} + {η}_{v}^{chg} {p}_{t , v}^{emchg} Δ t - {p}_{t , v}^{emdsg} Δ t - {ξ}_{v} \frac{{S}_{t , v}}{{\sum }_{t ∈ T} {S}_{t , v}} \\ ∀ t ∈ T , v ∈ V & ( 10 ) \\ {soc}_{t , v} \geq {ξ}_{v} \begin{matrix}\frac{{S}_{t , v}}{{\sum }_{t ∈ T} {S}_{t , v}} & ∀ t ∈ T , v ∈ V\end{matrix} & ( 11 ) \\ 0 \leq {e}_{t , v}^{regdn} + {e}_{t , v}^{stopdsg} \leq {SoC}_{v}^{max} - \begin{matrix}{soc}_{t , v} & ∀ t ∈ T , v ∈ V\end{matrix} & ( 12 ) \\ 0 \leq {e}_{t , v}^{regup} + {e}_{t , v}^{stopchg} \leq \begin{matrix}{soc}_{t , v} - {SoC}_{v}^{min} & ∀ t ∈ T , v ∈ V\end{matrix} & ( 13 ) \\ \begin{matrix}{SoC}_{v}^{min} \leq {soc}_{t , v} \leq {SoC}_{v}^{max} & ∀ t ∈ T , v ∈ V\end{matrix} & ( 14 ) \\ \begin{matrix}{soc}_{t = \vert T \vert , v} = {SoC}_{v}^{init} & ∀ v ∈ V\end{matrix} & ( 15 )\end{matrix}$$

The constraints of equations 16 to 20 determine how much energy and at which periods regulation and energy market services can be provided. In equations 16 and 17, an individual EV can perform charging or discharging if it is available α_{t,v}, which is the availability of an EV of a tenant in period t in the apartment complex managed by the aggregator. An EV at a specific period t can either charge for the energy or the regulation down market as shown in the constraint of equation 16, or it can discharge for the energy or regulation up market as shown in the constraint of equation 17. This is managed in such constraints by the auxiliary binary variable z_{t,v} and the maximum power Pᵥ^{max} that an EV can provide. If an EV is scheduled to discharge in the energy market, the aggregator may decide to interrupt this discharging by scheduling regulation as shown in the constraint equation 18. The same rationale applies for the constraint of equation 19 to interrupt energy market charging. Since the aggregator must meet each EV's motion requirements, it can only interrupt charging that is in addition to energy obtained for motion as shown in the constraint equation 20.

$$\begin{matrix}\begin{matrix}0 \leq {p}_{t , v}^{emchg} Δ t + {e}_{t , v}^{regdn} \leq {α}_{t , v} ( {p}_{v}^{max} Δ t ) ( 1 - {z}_{t , v} ) & ∀ t ∈ T , v ∈ V\end{matrix} & ( 16 ) \\ \begin{matrix}0 \leq {p}_{t , v}^{emdsg} Δ t + {e}_{t , v}^{regup} \leq {α}_{t , v} ( {p}_{v}^{max} Δ t ) {z}_{t , v} & ∀ t ∈ T , v ∈ V\end{matrix} & ( 17 ) \\ \begin{matrix}0 \leq {e}_{t , v}^{stopdsg} \leq {p}_{t , v}^{emdsg} Δ t & ∀ t ∈ T , v ∈ V\end{matrix} & ( 18 ) \\ \begin{matrix}0 \leq {e}_{t , v}^{stopchg} \leq {p}_{t , v}^{emchg} Δ t & ∀ t ∈ T , v ∈ V\end{matrix} & ( 19 ) \\ \begin{matrix}{\sum }_{t ∈ T} {e}_{t , v}^{stopchg} \leq Δ t {\sum }_{t ∈ T} ( {p}_{t , v}^{emchg} ) - {ξ}_{v} & ∀ v ∈ V\end{matrix} & ( 20 )\end{matrix}$$

The last set of constraints for the aggregator are related to the regulation and energy market price-quantity-probability (“PQP”) curves. In the constraint of equation 21, binary variable w_{t,b}^{up} will be active at one specific segment b when parameter PQP_{b}^{up} equals π^{a}. This rationale applies to the constraints of equations 21 to 24. By deciding which segment of the CDF curves is active, a corresponding market price can be used in equation 1.

$$\begin{matrix}\begin{matrix}{\sum }_{b ∈ B} {w}_{t , b}^{up} \cdot {PQP}_{b}^{up} = {π}^{a} & ∀ t ∈ T\end{matrix} & ( 21 ) \\ \begin{matrix}{\sum }_{b ∈ B} {v}_{t , b}^{up} \cdot {PQP}_{b}^{RT} = {π}^{d} & ∀ t ∈ T\end{matrix} & ( 22 ) \\ \begin{matrix}{\sum }_{b ∈ B} {w}_{t , b}^{dn} \cdot {PQP}_{b}^{dn} = {φ}^{a} & ∀ t ∈ T\end{matrix} & ( 23 ) \\ \begin{matrix}{\sum }_{b ∈ B} {v}_{t , b}^{dn} \cdot {PQP}_{b}^{RT} = {φ}^{d} & ∀ t ∈ T\end{matrix} & ( 24 )\end{matrix}$$

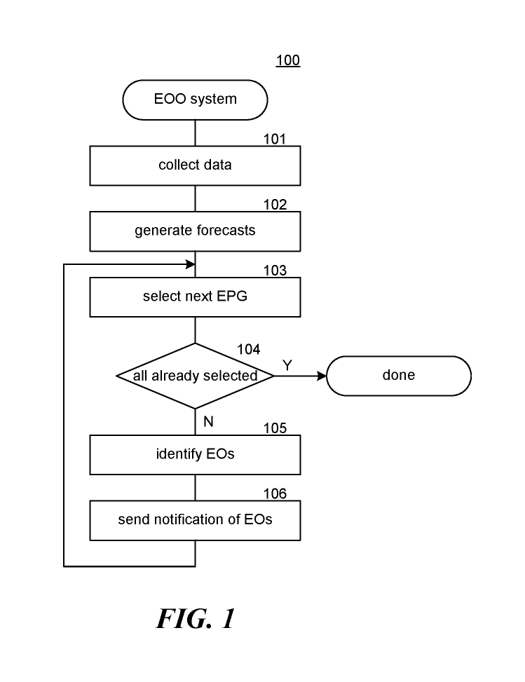

FIG. 1 is a flow diagram that illustrates the overall processing of the EOO system in some embodiments. The EOO system 100 identifies energy opportunities for EPGs and notifies the EPGs of the identified energy opportunities. In block 101, the system collects data from various data sources. The data that is collected includes attributes of the assets of the EPGs, wholesale and retail attributes and rules, and historical data such as weather data, asset operational data, market data, demand-response data, and so on. In block 102, the system generates various forecasts such as DA and RT energy market prices. In blocks 103-106, the system identifies energy opportunities for each EPG. In block 103, the system selects the next EPG. In decision block 104, if all the EPGs have already been selected, then the system completes, else the system continues at block 105. In block 105, the system identifies the energy opportunities for the selected EPG based on the collected data and the forecasts. In block 106, the component sends the identified energy opportunities for the selected EPG to the EPG and loops to block 103 to select the next EPG.

In some embodiments, the EOO system may be used to not only identify energy opportunities with the transmission-level (“TL”) energy marketplace, but also energy opportunities within a distribution-level (“DL”) energy marketplace. The DL energy marketplace, similar to the ISO TL energy marketplace, is expected to be transactional, open-access, and competitive. The DL marketplace allows suppliers and consumers connected to the distribution grid (directly or indirectly) to take advantage of energy opportunities at the distribution level. For example, the DL marketplace can enable EV aggregators, aggregators of commercial or industrial complexes, and so on to participate in the DL energy marketplace in much the same ways that suppliers and consumers participate in the ISO energy marketplace to help ensure smooth, efficient, and cost-effective operation of the local distribution grid. Indeed, any supplier or consumer on the local distribution grid may be allowed to participate in the DL energy marketplace. For example, a heating system for a single-family dwelling may request to receive notifications of energy opportunities relating to the DL energy marketplace from the EOO system. An energy opportunity may indicate that is more cost effective to start heating the dwelling at 6:00 am, rather than at 7:00 am. Another energy opportunity may indicate that the battery of an electric vehicle should be discharged to supply energy for the heating system from 6:00-11:00 pm.

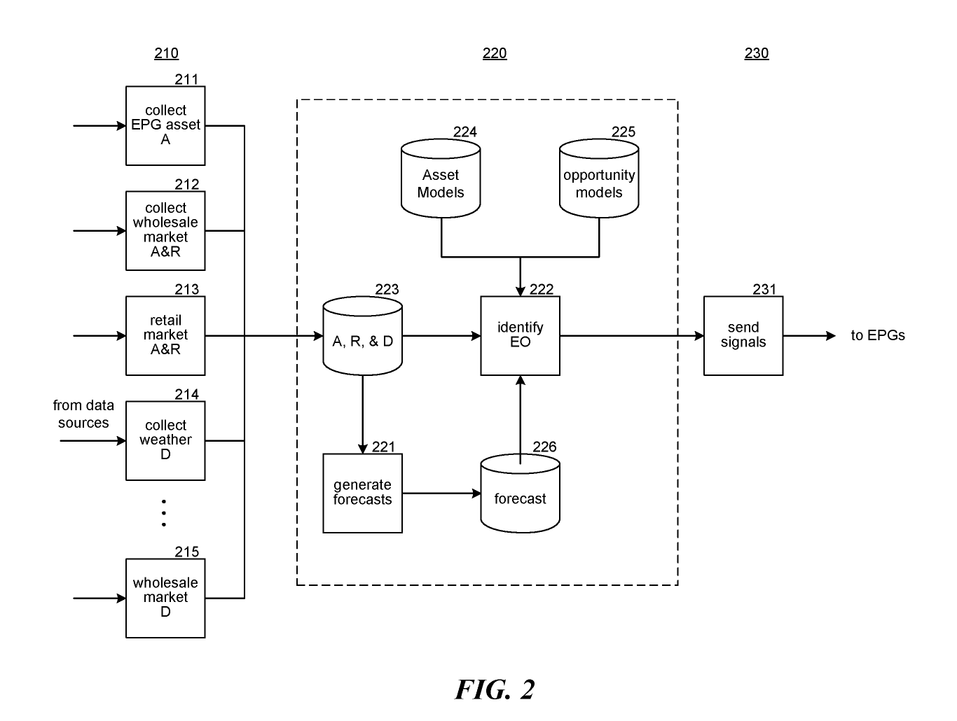

FIG. 2 is a block diagram that illustrates components of the EOO system in some embodiments. The EOO system includes a data acquisition layer 210, an energy opportunity identification layer 220, and a notification layer 230. The data acquisition layer includes various components 211-215 for collecting attributes, rules, and historical data. The components may provide user interfaces for the manual entering of data or may automatically access various data sources. For example, the collect EPG asset attribute component 211 may provide a user interface through which a representative of an EPG can enter attributes of the asset. Alternatively, or in addition, the component may automatically query the assets of the EPG to collect the needed attributes. Each asset may include electronics (e.g., an Internet of Things (“IoT”) device) for responding to queries. To collect information, the components 211-215 may access various application programming interfaces (“APIs”) of third-party suppliers of information; perform scraping of websites; direct that data be extracted from systems in a comma-separated values (“CSV”) format a JavaScript object notation (“JSON”) format, or eXtensible markup language (“XML”) format; subscribe to receive data published by various systems, and so on. The collected information is stored in an attributes, rules, and data (“A, R, & D”) storage 223. The energy opportunity identification layer includes a generate forecasts component 221 and an identify energy opportunities component 222. The generate forecasts component inputs the information of the A, R, & D storage to generate various types of forecasts that are stored in a forecast storage 226. The identify energy opportunities component inputs the forecasts and the attributes, rules, and data along with asset models of an asset models storage 224 and opportunity models of an opportunity models storage 225 and then identifies energy opportunities for the EPGs. The send signals component 231 of the notification layer sends notification signals relating to energy opportunities identified by the identify energy opportunities component to the various EPGs. Upon receiving the signals, the EPGs may automatically or manually schedule their assets to take advantage of the energy opportunities.

The computing devices and systems on which the EOO system may be implemented may include a central processing unit, input devices, output devices (e.g., display devices and speakers), storage devices (e.g., memory and disk drives), network interfaces, graphics processing units, accelerometers, cellular radio link interfaces, global positioning system devices, and so on. The input devices may include keyboards, pointing devices, touch screens, gesture recognition devices (e.g., for air gestures), head and eye tracking devices, microphones for voice recognition, and so on. The computing devices may include desktop computers, laptops, tablets, e-readers, personal digital assistants, smartphones, gaming devices, servers, and computer systems such as massively parallel systems. The computing devices may access computer-readable media that include computer-readable storage media and data transmission media. The computer-readable storage media are tangible storage means that do not include a transitory, propagating signal. Examples of computer-readable storage media include memory such as primary memory, cache memory, and secondary memory (e.g., DVD) and include other storage means. The computer-readable storage media may have recorded upon or may be encoded with computer-executable instructions or logic that implements the EOO system. The data transmission media is used for transmitting data via transitory, propagating signals or carrier waves (e.g., electromagnetism) via a wired or wireless connection.

The EOO system may be implemented on a variety of central computing systems such as high-performance computing systems and cloud-based computing systems. When implemented on a central computing system, the EOO system may take advantage of various computing techniques to improve execution efficiency. For example, the EOO system may schedule a separate thread of execution for each EPG to identify of energy opportunities for the EPGs in parallel. As another example, the EOO system may use various scheduling algorithms and load balancing techniques to ensure that energy opportunities are identified in a timely manner. The EOO system may also be implemented in a distributed manner by, for example, computing systems of suppliers, consumers, aggregators, controllers of assets, Internet-of-Thing devices, and so on that are connected via a public or private communications network. Each entity that uses the EOO system may be requested to provide computing resources for use by the EOO system for identifying energy opportunities for the entity or even other entities.

The EOO system may be described in the general context of computer-executable instructions, such as program modules and components, executed by one or more computers, processors, or other devices. Generally, program modules or components include routines, programs, objects, data structures, and so on that perform particular tasks or implement particular data types. Typically, the functionality of the program modules may be combined or distributed as desired in various embodiments. Aspects of the system may be implemented in hardware using, for example, an application-specific integrated circuit (“ASIC”).

In some embodiments, aspects of the EOO system may be implemented via a distributed ledger and records transaction in the distributed ledger. By recording transactions relating to the identification and notification of energy opportunities, bids and offers, historical data, and so on in the distributed ledger, various entities such as regulators, participants in the energy marketplace, and so on can have access to this information. Moreover, various components of the EOO system may be implemented as smart contracts that execute in the distributed ledger. For example, the EOO system may record a smart contract for each EPG. The smart contract for an EPG may identify the energy opportunities for that EPG, record a transaction for each identified energy opportunity, send notifications to the EPG, and so on. An EPG may also record transactions relating to its assets such as attributes of its assets, identified energy opportunities that were taken advantage of, and so on. Various entities of the energy marketplace may record transactions in the distributed ledger relating to prices, capacity, demand, incentive, rules, attributes, and so on. The distributed ledger may be a blockchain or non-blockchain distributed ledger.

The bitcoin system is an example of a distributed ledger. The bitcoin system was developed to allow electronic cash to be transferred directly from one party to another without going through a financial institution, as described in the white paper entitled “Bitcoin: A Peer-to-Peer Electronic Cash System” by Satoshi Nakamoto. A bitcoin (e.g., an electronic coin) is represented by a chain of transactions that transfers ownership from one party to another party. To transfer ownership of a bitcoin, a new transaction is generated and added to a stack of transactions in a block. The new transaction, which includes the public key of the new owner, is digitally signed by the owner with the owner's private key to transfer ownership to the new owner, as represented by the new owner public key. The signing by the owner of the bitcoin is an authorization by the owner to transfer ownership of the bitcoin to the new owner via the new transaction. Once the block is full, the block is “capped” with a block header that is a hash digest of all the transaction identifiers within the block. The block header is recorded as the first transaction in the next block in the chain, creating a mathematical hierarchy called a “blockchain.” To verify the current owner, the blockchain of transactions can be followed to verify each transaction from the first transaction to the last transaction. The new owner need only have the private key that matches the public key of the transaction that transferred the bitcoin. The blockchain creates a mathematical proof of ownership in an entity represented by a security identity (e.g., a public key), which in the case of the bitcoin system is pseudo-anonymous.

To ensure that a previous owner of a bitcoin did not double-spend the bitcoin (i.e., transfer ownership of the same bitcoin to two parties), the bitcoin system maintains a distributed ledger of transactions. With the distributed ledger, a ledger of all the transactions for a bitcoin is stored redundantly at multiple nodes (i.e., computers) of a blockchain network. The ledger at each node is stored as a blockchain. In a blockchain, the transactions are stored in the order that the transactions are received by the nodes. Each node in the blockchain network has a complete replica of the entire blockchain. The bitcoin system also implements techniques to ensure that each node will store the identical blockchain, even though nodes may receive transactions in different orderings. To verify that the transactions in a ledger stored at a node are correct, the blocks in the blockchain can be accessed from oldest to newest, generating a new hash of the block and comparing the new hash to the hash generated when the block was created. If the hashes are the same, then the transactions in the block are verified. The bitcoin system also implements techniques to ensure that it would be infeasible to change a transaction and regenerate the blockchain by employing a computationally expensive technique to generate a nonce that is added to the block when it is created. A bitcoin ledger is sometimes referred to as an Unspent Transaction Output (“UTXO”) set because it tracks the output of all transactions that have not yet been spent.

Although the bitcoin system has been very successful, it is limited to transactions in bitcoins or other cryptocurrencies. Blockchains have been developed to support transactions of any type, such as those relating to the sale of vehicles, sale of financial derivatives, sale of stock, payments on contracts, and so on. Such transactions use identity tokens to uniquely identify something that can be owned or can own other things. An identity token for a physical or digital asset is generated using a cryptographic one-way hash of information that uniquely identifies the asset. Tokens also have an owner that uses an additional public/private key pair. The owner public key or hash of the owner public key is set as the token owner identity, and when performing actions against tokens, ownership proof is established by providing a signature generated by the owner private key and validated against the public key or hash of the public key listed as the owner of the token. A person can be uniquely identified, for example, using a combination of a user name, social security number, and biometric (e.g., fingerprint). The creation of an identity token for an asset in a blockchain establishes provenance of the asset, and the identity token can be used in transactions (e.g., buying, selling, insuring) involving the asset stored in a blockchain, creating a full audit trail of the transactions.

To enable more complex transactions than bitcoin can support, some systems use “smart contracts.” A smart contract is computer code that implements transactions of a contract. The computer code may be executed in a secure platform (e.g., an Ethereum platform, which provides a virtual machine) that supports recording transactions in blockchains. In addition, the smart contract itself is recorded as a transaction in the blockchain using an identity token that is a hash (i.e., identity token) of the computer code so that the computer code that is executed can be authenticated. When deployed, a constructor of the smart contract executes, initializing the smart contract and its state. The state of a smart contract is stored persistently in the blockchain. When a transaction is recorded against a smart contract, a message is sent to the smart contract, and the computer code of the smart contract executes to implement the transaction (e.g., debit a certain amount from the balance of an account). The computer code ensures that all the terms of the contract are complied with before the transaction is recorded in the blockchain.

When a message is sent to a smart contract to record a transaction, the message is sent to each node that maintains a replica of the blockchain. Each node executes the computer code of the smart contract to implement the transaction. For example, if 100 nodes each maintain a replica of a blockchain, then the computer code executes at each of the 100 nodes. When a node completes execution of the computer code, the result of the transaction is recorded in the blockchain. The nodes employ a consensus algorithm to decide which transactions to keep and which transactions to discard. Although the execution of the computer code at each node helps ensure the authenticity of the blockchain, it requires large amounts of computer resources to support such redundant execution of computer code.

Although blockchains can effectively store transactions, the large amount of computer resources, such as storage and computational power, needed to maintain all the replicas of the blockchain can be problematic. To overcome this problem, some systems for storing transactions do not use blockchains, but rather have each party to a transaction maintain its own copy of the transaction. One such system is the Corda system developed by R3, Ltd., which provides a decentralized distributed ledger platform in which each participant in the platform has a node (e.g., computer system) that maintains its portion of the distributed ledger. When parties agree on the terms of a transaction, a party submits the transaction to a notary, which is a trusted node, for notarization. The notary maintains an UTXO database of unspent transaction outputs. When a transaction is received, the notary checks the inputs to the transaction against the UTXO database to ensure that the outputs that the inputs reference have not been spent. If the inputs have not been spent, the notary updates the UTXO database to indicate that the referenced outputs have been spent, notarizes the transaction (e.g., by signing the transaction or a transaction identifier with a public key of the notary), and sends the notarization to the party that submitted the transaction for notarization. When the party receives the notarization, the party stores the notarization and provides the notarization to the counterparties.

In the following, examples are provided of the types of attributes, rules, and data that are collected by the data acquisition layer.

### EPG Attributes

1. Generic asset attributes
a. Type
b. Purpose
c. Market location of end-point asset in the ISO map (i.e., which zone or utility)
d. Geographical location

2. If supply asset, then
a. Type of generator
b. Rated capacity
c. Contracted capacity
d. Type of generator

3. If load asset, then
a. Type of load
b. Utility rate structure

### Wholesale Market Attributes and Rules

The attributes and rules are derived from proceedings, market opportunities, warnings, and so on published by various ISOs and participants.

### Retail Market Attributes and Rules

The attributes and rules include load-side opportunities (e.g., smart metering, smart thermostat incentives, etc.), new tariffs introduced, old tariff changes, and business process changes, among others.

### Historical Data

1. Historical Weather
a. High/low temperatures
b. Average temperatures
c. Precipitation
d. Solar irradiation
e. Cloud coverage

2. End-Point Asset Historical Operations
a. If generator,
   i. Production amount
   ii. Downtime for maintenance
b. If load,
   i. Consumption amounts (monthly, daily, interval)

3. Wholesale Market Historical Data
a. DA Energy Market Price
   i. Collected daily in intervals for each market and each zone in the market
   ii. Collected daily in intervals for each generator zone
b. RT Energy Market Price
   i. Collected every interval for each market and each zone in the market
   ii. Collected every interval for each generator zone
c. DA Capacity Market Price
   i. Collected daily in intervals for various reserve/regulation services in each market
d. Reliability-Based Demand Response
   i. Collected daily to monitor whether demand response events took place, for how long, and compensation
e. Economic-Based Demand Response
   i. Collected daily to monitor whether demand response events took place, for how long, and compensation
f. Integrated Capacity Resources (iCAP)
   i. Capacity market is monitored to understand capacity payments, auction timing, etc.
g. Renewable Energy Credits (REC)

4. Retail Utility Historical and Upcoming Changes
a. Utility rates
b. Utility-level reliability-based demand response
c. Utility-level economic-based demand response

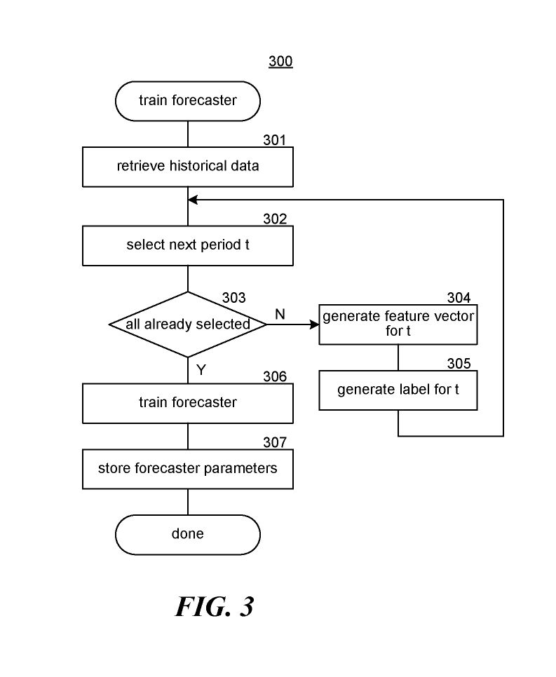

FIG. 3 is a flow diagram that illustrates the processing of a train forecaster component of the EOO system in some embodiments. A train forecaster component 300 employs various machine learning techniques to train a forecaster to generate forecasts for data based on historical data. The EOO system uses the forecast data to help identify energy opportunities. In block 301, the component retrieves historical data relating to a data item to be forecast. For example, if the data item to be forecast is the DA energy market price, then the historical data may include historical DA energy market prices, historical supply and demand, historical temperature data, and so on. In blocks 302-305, the component loops, generating training data based on historical data for a certain period for training the forecaster. In block 302, the component selects the next period. In decision block 303, if all the periods have already been selected, then the component continues at block 306, else the component continues at block 304. In block 304, the component generates a feature vector for the selected period. The feature vector includes a value for each feature that may influence the data item to be forecast. In block 305, the component generates a label for the feature vector. For example, the label may be the actual DA energy market price for the selected period. The component then loops to block 302 to select the next period. In block 306, the component trains the forecaster using the labeled featured vectors as training data. In block 307, component stores the parameters that were learned for the forecasting and then completes.

The train forecaster component may employ various types of machine learning techniques to train the forecaster. The machine learning techniques may be based on an autoregressive integrated moving average (“ARIMA”) model, a support vector machine (“SVM”), adaptive boosting (“AdaBoost”), a neural network model, and so on.

ARIMA employs a regression based on differences in prior values to predict future values. A support vector machine operates by finding a hyper-surface in the space of possible inputs. The hyper-surface attempts to split the positive examples (e.g., feature vectors for photographs) from the negative examples (e.g., feature vectors for graphics) by maximizing the distance between the nearest of the positive and negative examples to the hyper-surface. This allows for correct classification of data that is similar to but not identical to the training data. Various techniques can be used to train a support vector machine.

Adaptive boosting is an iterative process that runs multiple tests on a collection of training data. Adaptive boosting transforms a weak learning algorithm (an algorithm that performs at a level only slightly better than chance) into a strong learning algorithm (an algorithm that displays a low error rate). The weak learning algorithm is run on different subsets of the training data. The algorithm concentrates more and more on those examples in which its predecessors tended to show mistakes. The algorithm corrects the errors made by earlier weak learners. The algorithm is adaptive because it adjusts to the error rates of its predecessors. Adaptive boosting combines rough and moderately inaccurate rules of thumb to create a high-performance algorithm. Adaptive boosting combines the results of each separately run test into a single, very accurate classifier. Adaptive boosting may use weak classifiers that are single-split trees with only two leaf nodes.

A neural network model has three major components: architecture, cost function, and search algorithm. The architecture defines the functional form relating the inputs to the outputs (in terms of network topology, unit connectivity, and activation functions). The search in weight space for a set of weights that minimizes the objective function is the training process. In one embodiment, the classification system may use a radial basis function (“RBF”) network and a standard gradient descent as the search technique.

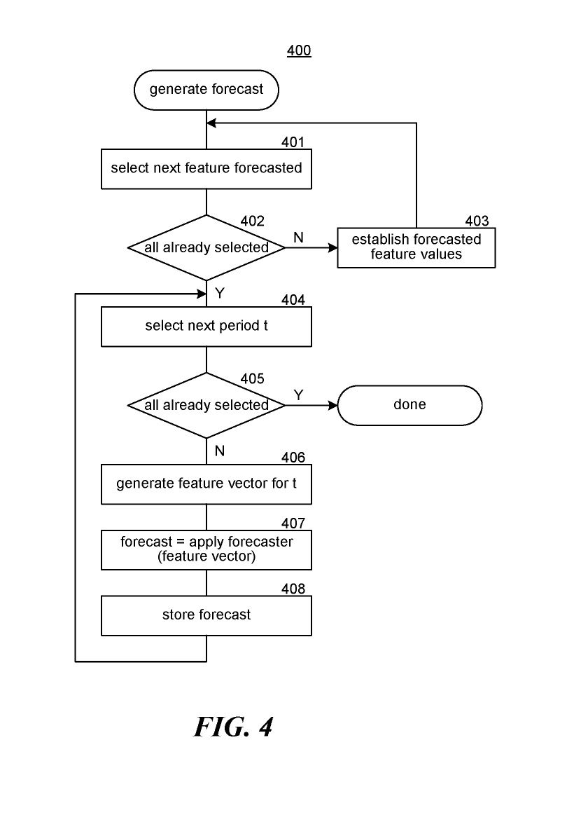

FIG. 4 is a flow diagram that illustrates the processing of a generate forecast component of the EOO system in some embodiments. The generate forecast component 400 is invoked to generate forecasts for a data item over various periods. In blocks 401-403, the component loops, establishing feature values of predicted features of the feature vector to input to the forecaster. In block 401, the component selects the next feature of the feature vector that was used when training the forecaster and that is itself a forecast value. For example, if the data item to be forecast is the DA energy market price, then the forecast may be based on forecasts of supply and demand that need to be established by running other forecasters. In decision block 402, if all the features have already been selected, then the component continues at block 404, else the component continues at block 403. In block 403, the component establishes a forecast value for the selected feature and loops to block 401 to select the next feature. In blocks 404-408, the component loops, generating a forecast for each period. In block 404, the component selects the next period. In decision block 405, if all the periods have already been selected, then the component completes, else the component continues at block 406. In block 406, the component generates the feature vector for the period. In block 407, the component applies the forecaster for the data item to the feature vector to generate a forecast for the data item for the period. In block 408, the component stores the forecast data item and then loops to block 404 to select the next period.

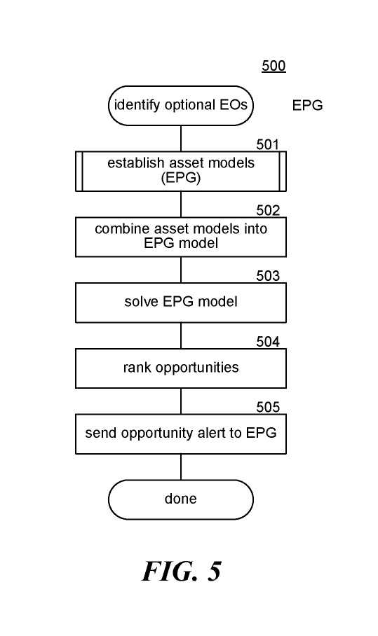

FIG. 5 is a flow diagram that illustrates the processing of an identify optimal energy opportunities component of the EOO system in some embodiments. The identify optimal energy opportunities component 500 is an example of an identify energy opportunities component of the EOO system. The identify optimal energy opportunities component is invoked for an EPG and identifies and sends energy opportunities to the EPG. In block 501, the component invokes an establish asset models component, passing an indication of the EPG, to generate an asset model for each asset of the EPG. In block 502, the component combines the asset models into an overall EPG model. In block 503, the component solves the overall EPG model to identify the optimal energy opportunities for the EPG. In block 504, the component ranks the energy opportunities identified by the solution. For example, an energy opportunity relating to full participation in a reserve market may be ranked high when the DA energy market price is forecast to be low. In general, the ranking of energy opportunities may be based on maximization of profit or minimization of cost. In block 505, the component sends an energy opportunity alert to the EPG to notify the EPG of the energy opportunities and then completes.

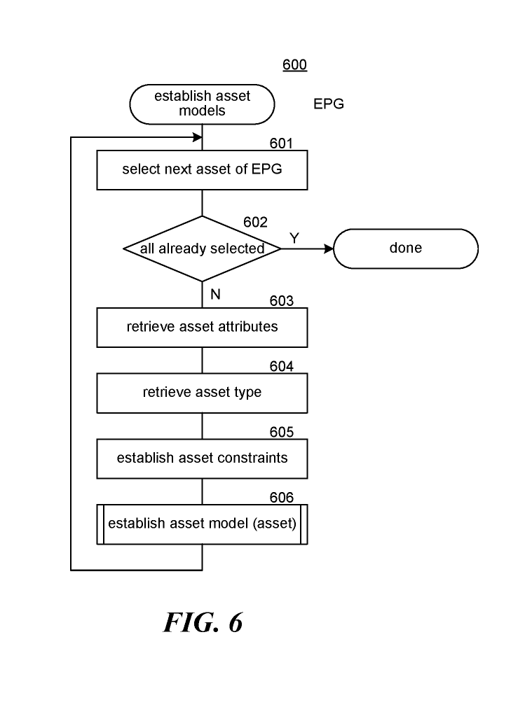

FIG. 6 is a flow diagram that illustrates the processing of an establish asset models component of the EOO system in some embodiments. The establish asset models component 600 is invoked to establish the asset models for an EPG. In block 601, the component selects the next asset of the EPG. In decision block 602, if all the assets have already been selected, then the component completes, else the component continues at block 603. In block 603, the component retrieves the attributes of the asset. In block 604, the component retrieves the type of the asset. In block 605, the component establishes the constraints for the assets based on the attributes and the type of asset. The EOO system may provide predefined constraints for classes of assets whose parameters are set based on the attributes of the individual assets of an EPG. In block 606, the component invokes an establish asset model component, passing an indication of the asset, and then loops to block 601 to select the next asset.

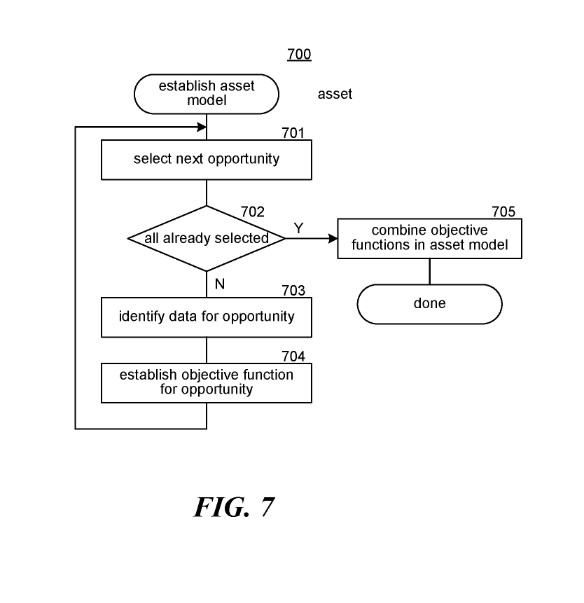

FIG. 7 is a flow diagram that illustrates the processing of an establish asset model component of the EOO system in some embodiments. The establish asset model component 700 is passed an indication of an asset and generates an asset model that combines the objective functions for various energy opportunities. The EOO system accesses objective functions that are defined for each energy opportunity. In block 701, the component selects the next energy opportunity. In decision block 702, if all the energy opportunities have already been selected, then the component continues at block 705, else the component continues at block 703. In block 703, the component identifies the data for the selected energy opportunity. The identified data may be stored in the A, R, & D storage or in the forecast storage. In block 704, the component establishes an objective function for the energy opportunity based on the identified data and loops to block 701 to select the next energy opportunity. In block 705, the component combines the objective functions into an asset model for the asset and then completes.

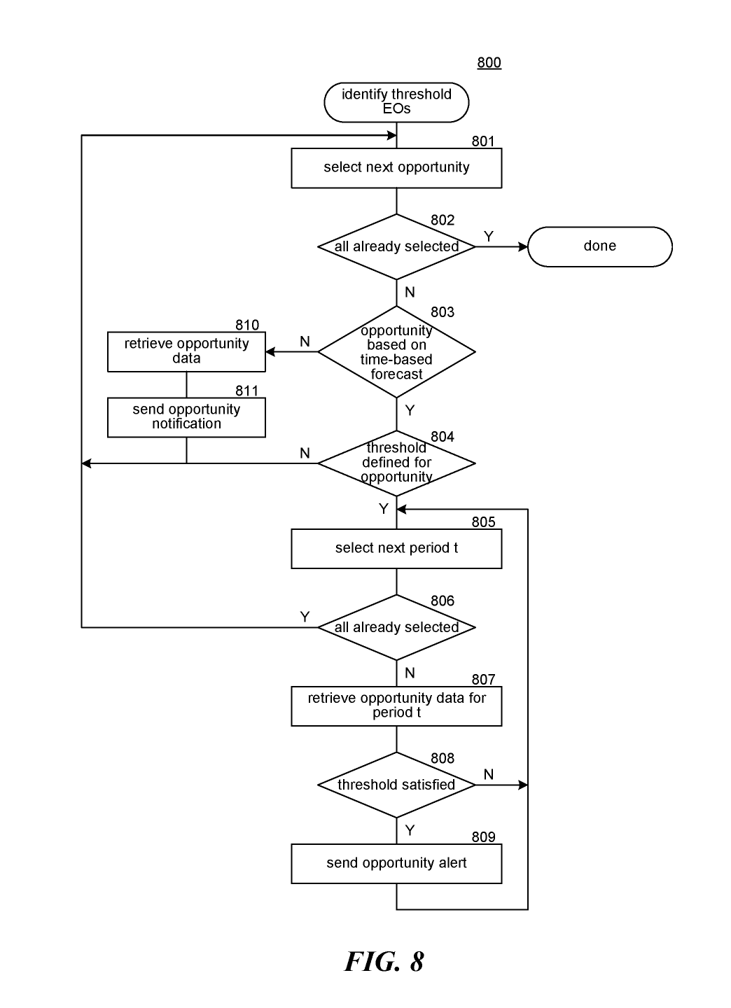

FIG. 8 is a flow diagram that illustrates the processing of an identify threshold energy opportunities component of the EOO system in some embodiments. The identify threshold energy opportunities component 800 is another example of an identify energy opportunities component of the EOO system. The identify threshold energy opportunities component is invoked to identify energy opportunities based on a threshold set by an EPG. For example, the owner of an energy storage system may want to know of an energy opportunity in which the price of electrical power is below a certain threshold value. In block 801, the component selects the next energy opportunity. In decision block 802, if all the energy opportunities have already been selected, then the component completes, else the component continues at block 803. In decision block 803, if the selected energy opportunity is based on a time-based forecast, then the component continues at block 804, else the component continues at block 810. In decision block 804, if a threshold is defined by the EPG for the selected energy opportunity, then the component continues at block 805, else the component loops to block 801 to select the next energy opportunity. In block 805, the component selects the next period of interest. In decision block 806, if all the periods have already been selected, then the component loops to block 801 to select the next energy opportunity, else the component continues at block 807. In block 807, the component retrieves the energy opportunity data for the selected energy opportunity for the selected period. In decision block 808, if the threshold is satisfied for the retrieved energy opportunity data, then the component continues at block 809, else the component loops to block 805 to select the next period. In block 809, the component sends an energy opportunity alert to the EPG and then loops to block 805 to select the next period. In block 810, the component retrieves energy opportunity data for the selected energy opportunity. In block 811, the component sends a notification of the selected energy opportunity to the EPG and then loops to block 801 to select the next opportunity.

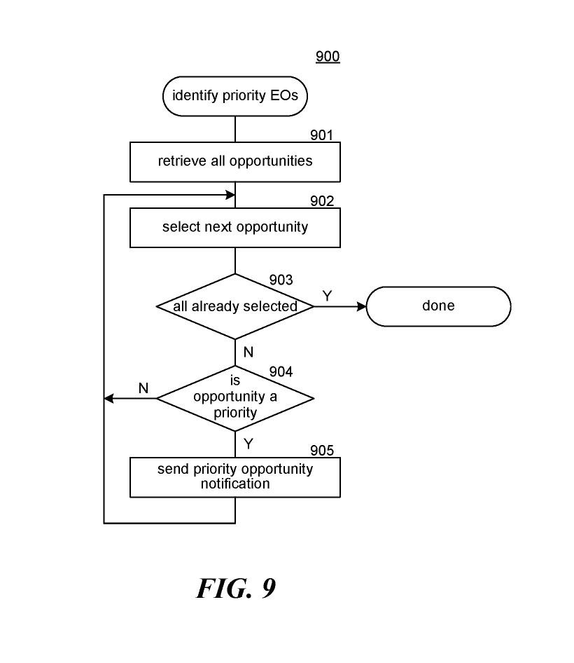

FIG. 9 is a flow diagram that illustrates processing of an identify priority energy opportunities component of the EOO system in some embodiments. The identify priority energy opportunities component 900 is another example of an identify energy opportunities component of the EOO system. The identify priority energy opportunities component is invoked to identify opportunities that have been identified by an EPG as being a priority. An EPG could identify all energy opportunities as being priorities. In block 901, the component retrieves all the energy opportunities. In block 902, the component selects the next energy opportunity. In decision block 903, if all the energy opportunities have already been selected, then the component completes, else component continues at block 904. In decision block 904, if the selected energy opportunity is a priority energy opportunity for the EPG, then the component continues at block 905, else the component loops to block 902 to select the next energy opportunity. In block 905, the component sends a priority energy opportunity notification to the EPG and then loops to block 902 to select the next energy opportunity.

The following paragraphs describe various embodiments of aspects of the EOO system. An implementation of the EOO system may employ any combination of the embodiments. The processing described below may be performed by a computing device with a processor that executes computer-executable instructions stored on a computer-readable storage medium that implements the EOO system.

In some embodiments, a method performed by a computing system for identifying energy opportunities for assets during a target period is provided. The method accesses attributes of assets, historical data relating to an energy market, and values for forecast parameters during the target period. For each asset, the method establishes constraints for the asset based on attributes of the asset and establishes an asset model that is a combination of one or more objective functions for energy opportunities for the asset and the established constraints. The objective functions is based on one or more of attributes of the assets, historical data, or values for the forecast parameters. The method combines the asset models into an overall model for the assets. The method identifies a solution for the overall model that optimizes the energy opportunities for the assets during the target period. In some embodiments, for each of a plurality of forecast parameters, the method generates a forecast of the value of the forecast parameter based on the historical data. In some embodiments, the assets are associated with an end-point group and further comprising sending a notification of the identified solution to a computing system of the end-point group. In some embodiments, a solution is identified for an overall model for each of a plurality of groups of assets. In some embodiments, the energy opportunities are identified for a series of target periods and the identifying of a solution identifies an overall solution for the series of target periods. In some embodiments, during intervals of the target period, the method identifies energy opportunities for the assets based on real-time data relating to an energy market. In some embodiments, the method controls operation of the assets based on the identified solution. In some embodiments, an asset is an energy load and an energy opportunity is based on a preference for use of clean energy. In some embodiments, the energy opportunities are based on one or more of advance pricing, real-time pricing, reserve pricing, negative pricing, scarcity pricing, incentive pricing, emissions pricing, and capacity pricing. In some embodiments, the historical data relates to one or more of weather conditions, asset historical operations, advance pricing, real-time pricing, capacity pricing, renewable energy credits, and demand response events. In some embodiments, an asset is an energy load and an asset is an energy supply.

In some embodiments, a computing system for identifying energy opportunities for assets during a target period is provided. The computing system comprises one or more computer-readable storage mediums storing computer-executable instructions and one or more processors for executing the computer-executable instructions stored in the one or more computer-readable storage mediums. The instructions control the computing system to collect attributes of assets and historical data relating to an energy market. The instructions control the computing system to generate values for forecast parameters during the target period. For each of a plurality of end-point groups of assets, for each asset of an end-point group, the instructions control the computing system to establish constraints for the asset based on attributes of the asset; and establish an asset model that is a combination of one or more objective functions for energy opportunities for the asset and the established constraints. The objective functions are based on one or more of attributes of the assets, historical data, or values for the forecast parameters. The instructions control the computing system to identify a solution for the asset models of the end-point group that optimizes the energy opportunities for the assets of the end-point group during the target period. The instructions control the computing system to provide the identified solution to the end-point group. In some embodiments, the energy opportunities are identified for a series of target periods and the identifying of a solution identifies an overall solution for the series of target periods. In some embodiments, the instructions further comprise instructions that control the computing system to during intervals of the target period, identify energy opportunities for the assets based on real-time data relating to an energy market. In some embodiments, the instructions further comprise instructions that control the computing system to control operation of the assets based on the identified solution. In some embodiments, an asset is an energy load and an energy opportunity is based on a preference for use of clean energy. In some embodiments, the energy opportunities are based on one or more of advance pricing, real-time pricing, reserve pricing, negative pricing, scarcity pricing, incentive pricing, emissions pricing, and capacity pricing. In some embodiments, the instructions further comprise instructions that control the computing system to combine the asset models for an end-point group of assets into an overall model for the end-point group and wherein the instructions that identify a solution identify a solution for the overall model. In some embodiments, the instructions that generate values for forecast parameters apply machine learning techniques to generate the values. In some embodiments, the computer-executable instructions further control the computing system to allocate a separate thread of execution for each end-point group so that identifying of opportunities for end-point groups can be performed in parallel.

In some embodiments, a method performed by a computing system for identifying energy opportunities for end-point groups of assets for a target period is provided. For each end-point group, the method performs the following: For each of the energy opportunities, the method establishes a threshold for a parameter relating to the energy opportunity for the end-point group. For each of a plurality of intervals of the target period, for each of the energy opportunities, the method retrieves data relating to the energy opportunity; determines whether a threshold for a parameter relating to the energy opportunity has been satisfied, and upon determining that the threshold for a parameter relating to the energy opportunity has been satisfied, notifies the end-point group that the threshold relating to the energy opportunity has been satisfied. In some embodiments, the method further forecasts values for a parameter relating to an energy opportunity during the target period. In some embodiments, an end-point group includes one or more load assets and one or more energy assets.

In some embodiments, a method performed by a computing system for providing notifications of energy opportunities for end-point groups of assets for a target period is provided. For each end-point group, for each of the energy opportunities, the method retrieves data relating to the energy opportunity and notifies the end-point group of the energy opportunity. In some embodiments, the method further receives for an end-point group an indication of priority energy opportunities for the end-point group wherein the notifying only notifies that end-point group of priority energy opportunities for the end-point group. In some embodiments, an end-point group includes one or more load assets and one or more energy assets.

Although the subject matter has been described in language specific to structural features and/or acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

I/We claim:

1. A method performed by a computing system for identifying energy opportunities for assets during a target period, the method comprising:
accessing attributes of assets;
accessing historical data relating to an energy market;
accessing values for forecast parameters during the target period;
for each asset,
establishing constraints for the asset based on attributes of the asset; and
establishing an asset model that is a combination of one or more objective functions for energy opportunities for the asset and the established constraints, the objective functions based on one or more of attributes of the assets, historical data, or values for the forecast parameters;
combining the asset models into an overall model for the assets; and
identifying a solution for the overall model that optimizes the energy opportunities for the assets during the target period.

2. The method of claim 1 further comprising, for each of a plurality of forecast parameters, generating a forecast of the value of the forecast parameter based on the historical data.

3. The method of claim 1 wherein the assets are associated with an end-point group and further comprising sending a notification of the identified solution to a computing system of the end-point group.

4. The method of claim 1 wherein a solution is identified for an overall model for each of a plurality of groups of assets.

5. The method of claim 1 wherein the energy opportunities are identified for a series of target periods and the identifying of a solution identifies an overall solution for the series of target periods.

6. The method of claim 1 further comprising, during intervals of the target period, identifying energy opportunities for the assets based on real-time data relating to an energy market.

7. The method of claim 1 further comprising controlling operation of the assets based on the identified solution.

8. The method of claim 1 wherein an asset is an energy load and an energy opportunity is based on a preference for use of clean energy.

9. The method of claim 1 wherein the energy opportunities are based on one or more of advance pricing, real-time pricing, reserve pricing, negative pricing, scarcity pricing, incentive pricing, emissions pricing, and capacity pricing.

10. The method of claim 1 wherein the historical data relates to one or more of weather conditions, asset historical operations, advance pricing, real-time pricing, capacity pricing, renewable energy credits, and demand response events.

11. The method of claim 1 wherein an asset is an energy load and an asset is an energy supply.

12. A computing system for identifying energy opportunities for assets during a target period, the computing system comprising:
one or more computer-readable storage mediums storing computer-executable instructions for controlling the computing system to:
collect attributes of assets and historical data relating to an energy market;
generate values for forecast parameters during the target period;
for each of a plurality of end-point groups of assets,
for each asset of an end-point group,
establish constraints for the asset based on attributes of the asset; and
establish an asset model that is a combination of one or more objective functions for energy opportunities for the asset and the established constraints, the objective functions based on one or more of attributes of the assets, historical data, or values for the forecast parameters;
identify a solution for the asset models of the end-point group that optimizes the energy opportunities for the assets of the end-point group during the target period; and
provide the identified solution to the end-point group; and
one or more processors for executing the computer-executable instructions stored in the one or more computer-readable storage mediums.

13. The computing system of claim 12 wherein the energy opportunities are identified for a series of target periods and the identifying of a solution identifies an overall solution for the series of target periods.

14. The computing system of claim 12 wherein the instructions further comprise instructions that control the computing system to during intervals of the target period, identify energy opportunities for the assets based on real-time data relating to an energy market.

15. The computing system of claim 12 wherein the instructions further comprise instructions that control the computing system to control operation of the assets based on the identified solution.

16. The computing system of claim 12 wherein an asset is an energy load and an energy opportunity is based on a preference for use of clean energy.

17. The computing system of claim 12 wherein the energy opportunities are based on one or more of advance pricing, real-time pricing, reserve pricing, negative pricing, scarcity pricing, incentive pricing, emissions pricing, and capacity pricing.

18. The computing system of claim 12 wherein the instructions further comprise instructions that control the computing system to combine the asset models for an end-point group of assets into an overall model for the end-point group and wherein the instructions that identify a solution identify a solution for the overall model.

19. The computing system of claim 12 wherein the instructions that generate values for forecast parameters apply machine learning techniques to generate the values.

20. The computing system of claim 12 wherein the computer-executable instructions further control the computing system to allocate a separate thread of execution for each end-point group so that identifying of opportunities for end-point groups can be performed in parallel.

21. A method performed by a computing system for identifying energy opportunities for end-point groups of assets for a target period, the method comprising:
for each end-point group,
for each of the energy opportunities, establishing a threshold for a parameter relating to the energy opportunity for the end-point group; and
for each of a plurality of intervals of the target period,
for each of the energy opportunities,
retrieving data relating to the energy opportunity;
determining whether a threshold for a parameter relating to the energy opportunity has been satisfied; and
upon determining that the threshold for a parameter relating to the energy opportunity has been satisfied, notifying the end-point group that the threshold relating to the energy opportunity has been satisfied.

22. The method of claim 21 further comprising forecasting values for a parameter relating to an energy opportunity during the target period.

23. The method of claim 21 wherein an end-point group includes one or more load assets and one or more energy assets.

24. A method performed by a computing system for providing notifications of energy opportunities for end-point groups of assets for a target period, the method comprising:
for each end-point group,
for each of the energy opportunities,
retrieving data relating to the energy opportunity; and
notifying the end-point group of the energy opportunity.

25. The method of claim 24 further comprising receiving for an end-point group an indication of priority energy opportunities for the end-point group wherein the notifying only notifies that end-point group of priority energy opportunities for the end-point group.

26. The method of claim 24 wherein an end-point group includes one or more load assets and one or more energy assets.
